(19) United States
(12) Patent Application Publication
(10) Pub. No.: US 2010/0012042 A1
(43) Pub. Date: Jan. 21, 2010

(54) BOWL

(76) Inventor: Long Sin Victor Lee, Singapore (SG)

Correspondence Address: GREER, BURNS & CRAIN, 300 S WACKER DR, 25TH FLOOR, CHICAGO, IL, 60606, US

(21) Appl. No.: 12/444,319

(22) PCT Filed: Oct. 3, 2007
(86) PCT No.: PCT/SG2007/000335

§ 371 Date: Apr. 3, 2009

(30) Foreign Application Priority Data
Oct. 4, 2006 (SG) 200606913-2

(51) Int. Cl. A01K 29/00

(52) U.S. Cl. 119/61.5

(57) ABSTRACT

A bowl for containing food for an animal, the bowl including: an interior volume for accommodating the food, the interior volume being defined by a base and an upwardly extending circumferential sidewall, wherein at least one protruding portion extends upwardly from the base of the bowl into the interior volume to obstruct the animal from consuming the food too fast.

### FIELD OF THE INVENTION

This invention relates to a bowl for containing food or drinking water for an animal and, particularly but not exclusively, for a pet dog.

### BACKGROUND OF THE INVENTION

There are a variety of bowls that are known in the art for containing food and drinking water for an animal to consume. These bowls may be made from any material such as plastics or ceramics and may have a base dimension greater than a rim dimension for providing stability when the animal is consuming the food or water contained in the bowl. The bowls may be circular or rectangular. The shape of the inside portion of the bowl is usually concave and the inside dimension of the bowl typically increases from the base upward. The wall thickness of the bowls is typically uniform.

Due to keen competition for food in the wild, animals such as dogs have developed an innate survival instinct of eating quickly. They tend to rip off chunks of meat with their strong canines and swallow their food without much chewing. For domesticated dogs that are fed with bite-sized processed food, this innate instinct of fast eating leads them to sweep up the food, for example kibbles (dry pellet dog food), swallowing almost immediately without chewing. This sweeping action is known as lapping. In addition to lapping, a dog may also gobble (or “inhale”) food. The lack of chewing leads to digestive problems in pet dogs.

In the case where an animal drinks water from a bowl too fast, they may end up choking and/or vomiting. Also, for animals with long ears such as Cocker Spaniels, Bedlington Terriers, etc, there is a problem of their ears getting dipped into water when they are drinking the water in a bowl. If not dried properly especially in climates with high humidity, these wet ears may allow fungus and other microorganisms to breed, thus leading to infections.

It is fairly common for animal or pet owners to leave a filled water bowl on the ground. This might be done routinely or while the owner is away. However, the water in such bowls is exposed to the environmental elements and may be fouled with dust and microorganisms.

There is, therefore, a need for a bowl for containing food or drinking water for an animal that should try to solve some the above problems in the art. Particularly, there is a need for a bowl that allows an animal to moderate its speed of eating and drinking.

### SUMMARY OF THE INVENTION

In accordance with a preferred first aspect, there is provided a bowl for containing food for an animal, the bowl comprising:

an interior volume for accommodating said food, the interior volume being defined by a base and an upwardly extending circumferential sidewall,
wherein at least one protruding portion extends upwardly from the base of the bowl into the interior volume to obstruct the animal from consuming the food too fast.

Preferably, a plurality of spaced apart protruding portions extends upwardly from the base of the bowl into the interior volume of the bowl. More preferably, three spaced apart protruding portions extend upwardly from the base of the bowl into the interior volume of the bowl. Still more preferably, the three protruding portions are connected to each other by ridges to form a wishbone arrangement. Alternatively, any two or more protruding portions may be connected to each other by ridges to form any kind of arrangement such that the protruding portions and ridges form an obstruction in animal's access to the food in the bowl. The height of the three protruding portions may be different. Advantageously, the different heights of the protruding portions accommodate different animals having different muzzle sizes.

By “protruding portions”, it means any part of the bowl that protrudes from the base of the bowl and includes humps, bumps, bulge, lump, swelling, and the like.

By “spaced apart”, it means that the protruding portions may be spaced equally apart or not equally apart so long as these protruding portions provide an obstruction to an animal's access to the food in the bowl.

Advantageously, the protruding portions and the connecting ridges in the bowl prevent an animal from eating too fast because they prevent the animal from lapping and inhaling food placed in the bowl. By moderating the rate at which an animal eats, the bowl prevents indigestion in the animal and also prevents coprophagy (the act of feeding on excretion). In the latter case, indigestion caused by fast eating may affect nutrient absorption which is to be avoided. Poor digestion of the food may result in poor nutrient absorption by the gastrointestinal tract of the animal. Since animals may detect the strong presence of nutrients in their faeces, they tend to reprocess it by eating their faeces. Slower eating habits help to alleviate this problem and thus better nutrient absorption. Eating slower also makes an animal feel full first before realising that it has over-eaten. Advantageously, the bowl also acts as a useful weight management tool to prevent obese pet animals.

Preferably, the bowl is sized to hold a quantity of the food, the quantity being consumed in a single feeding. More preferably, the food may be dry and/or wet pet food.

In accordance with a preferred second aspect, there is provided a bowl for containing drinking water for an animal, the bowl comprising:

(a) an interior volume for accommodating said water, the interior volume is defined by a base and an upwardly extending circumferential sidewall; and
(b) a floating device for floating on said water,
wherein the floating device having a conduit for allowing said water to form a reservoir of water on a drinking surface of the floating device for the animal to consume the water.

Preferably, the floating device further comprises an interior cavity and the buoyancy of the floating device is determined by an amount of water introduced into the cavity. More preferably, the floating device has a water inlet for allowing the introduction of water into the interior cavity of the floating device. Any stopper such as a plug, valve, screw, cap or the like, may be used to prevent water from flowing out of the interior cavity of the floating device.

Preferably, the floating device has a depressed portion for allowing the reservoir of water to collect on the drinking surface of the floating device. To this end, the floating device may be cone-shaped. More preferably, the conduit is on the depressed portion.

Advantageously, the buoyancy of the device may be adjusted so that the size of the reservoir of water formed on the upper surface of the floating device will be ideal to suit an animal's optimal drinking speed. Also, the ears of the animal will not dip into the water in the bowl, and thus, will not get wet and the floating device minimises the contamination of the water remaining in the drinking bowl.

### BRIEF DESCRIPTION OF THE FIGURES

In order that the present invention may be fully understood and readily put into practical effect, there shall now be described by way of non-limitative examples only preferred embodiments of the present invention, the description being with reference to the accompanying illustrative figures.

In the figures:

FIG. 1 is a perspective view of a bowl according to an embodiment of the first aspect of the present invention;

FIG. 2 is a perspective view of a bowl according to an embodiment of the second aspect of the present invention; and

FIG. 3 is a perspective view of the floating device according to a bowl as shown in FIG. 2.

### DETAILED DESCRIPTION OF THE PREFERRED EMBODIMENTS

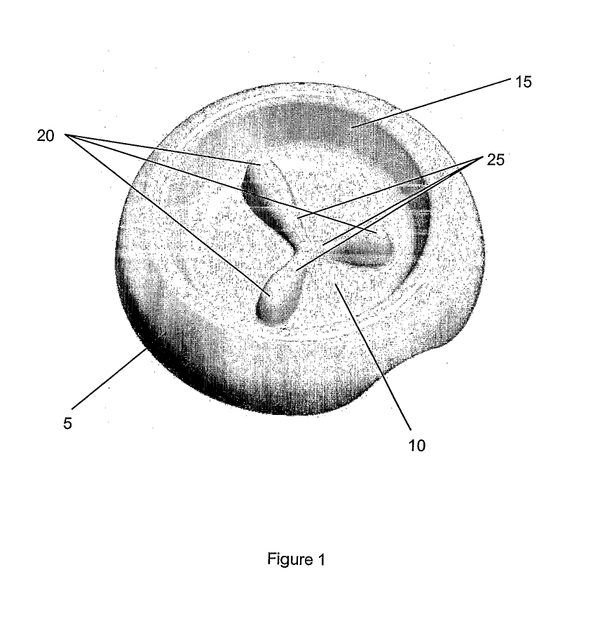

Referring to the accompanying drawings, FIG. 1 shows a bowl 5 for containing food for an animal. The bowl has a base 10 and an upwardly extending circumferential sidewall 15. Protruding portions 20 extend upwardly from the base 10 of the bowl 5 into the interior volume of the bowl 5. The three protruding portions 20 are connected to each other by ridges 25 to form a wishbone arrangement in the centre of the bowl 5. The heights of the three protruding portions 20 are different. The different heights of the protruding portions 20 accommodate different animals having different muzzle sizes. This wishbone configuration serves as an obstruction to deter an animal, such as a pet dog, from making a clean sweep of the food. The protruding portions 20 may be equally spaced apart in the bowl 5. Alternatively, to allow better obstruction to deter an animal from making a clean sweep of the food, the protruding portions 20 may not be spaced equally apart in the bowl 5. The ridges 25 are narrow elevations on the base 10 of the bowl 5 and may or may not be of the same height. This configuration also prevents the dog from “inhaling” the food as the obstruction inhibits a dog's muzzle from reaching too close to the food at the base 10 of the bowl 5. The ridges 25 allow food, for example kibbles, to be pushed over and/or rolled over in the bowl 5, and thus achieving a prolonged feeding time.

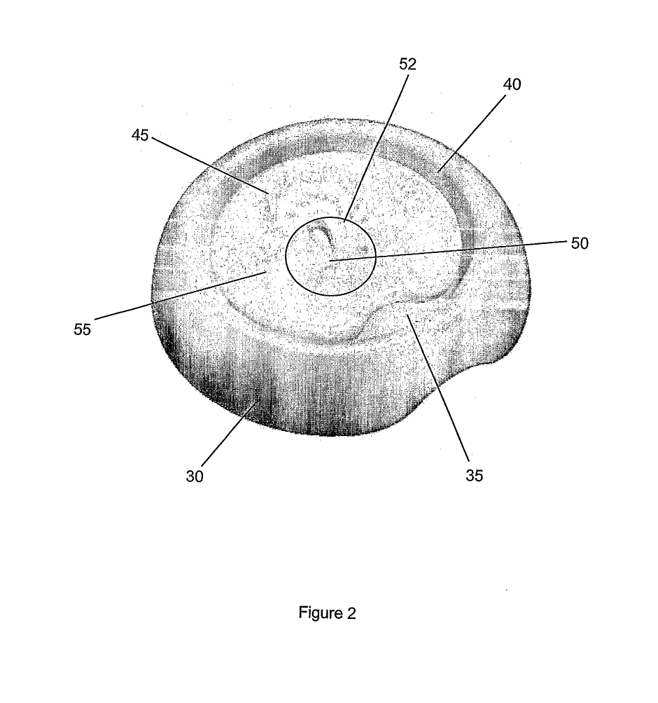

FIG. 2 shows a bowl for containing drinking water for an animal. Similar to the bowl shown in FIG. 1, this bowl 30 has a base 35 and an upwardly extending circumferential sidewall 40. A floating device 45 floats on the water in the bowl 30. The floating device is cone-shaped and has a depressed portion 55. A conduit 50 at the depressed portion 55 allows water in the bowl 30 to form a reservoir of water 52 on the drinking surface of the floating device 45 for the animal to consume the water.

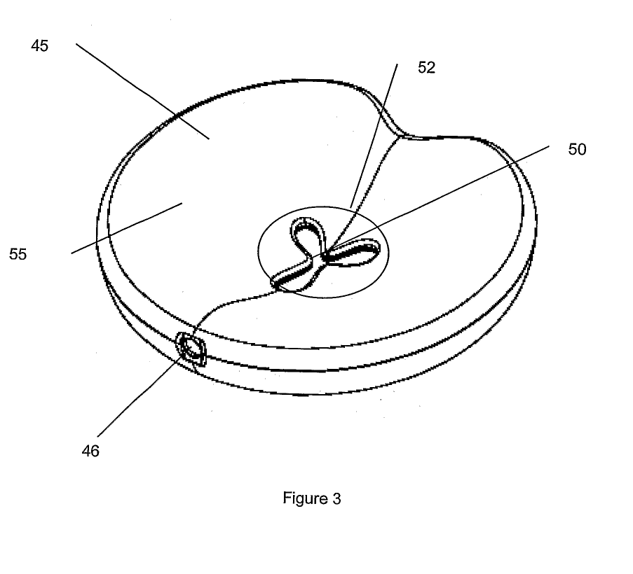

As shown in FIG. 3, the floating device 45 has an interior cavity (not shown in the Figures) and the buoyancy of the floating device 45 is determined by an amount of water introduced into the cavity 47. A water inlet 46 on a side of the floating device 45 allows for the introduction of water into the interior cavity of the floating device 45. Any stopper such as a plug, valve, screw, cap or the like, (not shown in the Figures) may be used to prevent water from flowing out of the interior cavity of the floating device 45. The buoyancy of the floating device 45 may be adjusted by varying the amount of water introduced into the cavity 47. This, in turn, determines the size of the reservoir of water 52 formed on the drinking surface of the floating device 45 so that the size of the reservoir of water 52 will be ideal to suit an animal's optimal drinking speed. The limitation of the size of the reservoir of water 52 and the obstruction of the floating device 45 also prevents an animal's ears from getting dipped into the water in the bowl 30.

Whilst there has been described in the foregoing description preferred embodiments of the present invention, it will be understood by those skilled in the technology concerned that many variations or modifications in details of design or construction may be made without departing from the present invention.

1. A bowl for containing food for an animal, the bowl comprising: an interior volume for accommodating said food, the interior volume being defined by a base and an upwardly extending circumferential sidewall, wherein at least one protruding portion extends upwardly from the base of the bowl into the interior volume to obstruct the animal from consuming the food too fast.

2. The bowl according to claim 1, wherein a plurality of spaced apart protruding portions extends upwardly from the base of the bowl into the interior volume of the bowl.

3. The bowl according to claim 2, wherein three spaced apart protruding portions extend upwardly from the base of the bowl into the interior volume of the bowl.

4. The bowl according to claim 3, wherein the three protruding portions are connected to each other by ridges to form a wishbone arrangement.

5. The bowl according to claim 4, wherein the height of the three protruding portions are different.

6. The bowl according to claim 1, wherein the bowl is sized to hold a quantity of the food, the quantity being consumed in a single feeding.

7. The bowl according to claim 6, wherein the food is dry and/or wet pet food.

8. (canceled)

9. A bowl for containing drinking water for an animal, the bowl comprising:
(a) an interior volume for accommodating said water, the interior volume is defined by a base and an upwardly extending circumferential sidewall; and (b) a floating device for floating on said water,
wherein the floating device having a conduit configured for allowing said water to form a reservoir of water on a drinking surface of the floating device for the animal to consume the water.

10. The bowl according to claim 9, wherein the floating device further comprises an interior cavity and the buoyancy of the floating device is determined by an amount of water introduced into the cavity.

11. The bowl according to claim 10, wherein the floating device further comprises a water inlet for allowing the introduction of water into the interior cavity of the floating device.

12. The bowl according to claim 9, wherein the floating device has a depressed portion for allowing the reservoir of water to collect on the drinking surface of the floating device.

13. The bowl according to claim 12, wherein the conduit is on the depressed portion.

14. The bowl according to claim 12, wherein the floating device is cone-shaped.

15. (canceled)
